(19) United States
(12) Patent Application Publication
(10) Pub. No.: US 2010/0154218 A1
(43) Pub. Date: Jun. 24, 2010

(54) METHOD AND SYSTEM FOR FABRICATING ROOF TRUSSES OR SIMILAR STRUCTURES

(76) Inventor: Matti Turulin, Kemi (FI)

Correspondence Address: CONNOLLY BOVE LODGE & HUTZ LLP, 1875 EYE STREET, N.W., SUITE 1100, WASHINGTON, DC, 20006, US

(21) Appl. No.: 11/993,687

(22) PCT Filed: Jun. 26, 2006
(86) PCT No.: PCT/FI06/00227

§ 371 Date: Mar. 9, 2010

(30) Foreign Application Priority Data
Jun. 23, 2005 (FI) 20050682

(51) Int. Cl. B23P 21/00; B27F 7/15; G06F 19/00

(52) U.S. Cl. 29/897.31; 29/283; 29/798; 29/281.5; 700/118

(57) ABSTRACT

In a method and system for fabrication of roof trusses or similar structures wherein the structure is assembled from members to be set against each other and the members are fastened to each other by means of nail plates or similar fastening means, data defining the structure is produced for controlling the fabrication, one or more planes (T1) are defined for assembly of the structure and several grippers (100, 101, 103, 104, 106, 107, 115, 116) are arranged to move and rotate according to the control in said plane whereby the grippers form the basic part of an assembly line or unit (M) for the structure, the grippers are controlled to move and rotate to certain places and positions and said certain members (4) are set in the grippers to form on them a basic part of the structure, and the structure is controlled to move on the grippers for carrying out the other steps of the assembly process.

### FIELD OF THE INVENTION

The invention is related to fabrication of roof trusses or similar structures from members to be set against each other which members are fastened to each other by means of nail plates or equivalent fastening means.

### BACKGROUND OF THE INVENTION

Trusses or similar structures are usually fabricated on a horizontal platform. On the platform, a pattern or jig is realized in one way or other which helps to assemble the members in place. The chords and diagonal members are usually arranged manually on the platform according to a pattern and fastened then to each other by means of nail plates.

The realization of the platform is a time consuming operation in which longitudinal and lateral stops are positioned and fastened on the platform for all members of the structure, usually according to a model fabricated for that purpose. Also this is usually made manually.

For facilitating the realization of jigs, universal platforms with slidably attached clampable stops have been achieved. Proposals have been made also to form a platform comprising stops moving on rails, the stops being positioned suitably for each truss structure and working at the same time as pressing supports for fastening the nail plates. Furthermore, proposals have been made to use laser technology for facilitating the realization of the jig. Also presses moving above the platform for fastening the members to each other and, on the other hand, the usage of a moving platform for transferring a structure thereby through a press have been proposed. Additionally, control of the operation of the presses, stops and platforms by means of a computer and suitable actuators have been included in various solutions.

Different solutions have been presented in the following publications, for example: U.S. Pat. Nos. 6,702,269, 6,318,251, 6,219,904, 6,170,163, 5,933,957, 5,873,567, 5,854,747, 5,646,859, 5,553,375, 5,361,495, 5,211,381, 5,211,108, 4,669,184, 4,379,426, 4,339,117, 4,154,164, 3,855,917, and 3,667,375, and GB Patent 1111570.

### SUMMARY OF THE INVENTION

An object of the invention is to present a new solution with which the fabrication of trusses or similar structures may be made significantly swifter and more efficient.

To achieve these objects, a method according to the invention for fabrication of roof trusses or similar structures, in which method the structure is assembled from members to be set against each other and the members are fastened to each other by means of nail plates or similar fastening means, is characterized in that which is defined in the characterizing part of the independent claim 1. Claims 2 to 5 define various embodiments of the method according to the invention.

To achieve these objects, a system according to the invention for fabrication of roof trusses or similar structures from members to be set against each other, which system comprises means for arranging the members to form said structure and means for fastening the members to each other by means of nail plates or similar fastening means, is characterized in that which is defined in the characterizing part of the independent claim 6. Claims 7 to 10 define various embodiments of the system according to the invention.

By means of the solution of the invention it is possible to realize a production line in which a roof truss or similar structure is fabricated in vertical position and is finally still in vertical position transferred forward for storing. The fabrication is effected in several stages so that in the first stage a truss or a part of a truss, e.g. the chords, is assembled or loaded in grippers. To said part of the truss in the grippers, further members may be set and fastened in place by means of staples, for example. After that or between the stages, the truss or part of the truss may be moved in the line to the nail plate pressing stage. The assembly of the next structure in another gripper unit may be started immediately as the preceding truss has been moved forward in the line or as a partial truss has been transferred aside to wait. The fabrication may be divided into further stages, so that partial structures are assembled in successive gripper units in the line and finally the partial structures are fastened to each other. One gripper unit or group of grippers may be used for assembling different structures according to control. The gripper units are also easy to change at need. In comparison with earlier working methods, the fabrication speed is increased and at the same time manual working steps in the preparatory phase and assembly are removed.

### BRIEF DESCRIPTION OF THE DRAWINGS

The invention and some of its embodiments are described in further detail in the following with reference to the accompanying drawings, in which:

FIGS. 1 to 2 present in side and plant view, respectively, an exemplary roof truss which may be fabricated by means of the method and system according to the invention,

FIG. 3 presents in side view the truss of FIG. 1 divided into two parts which may be assembled separately and combined together in the final phase of the fabrication,

FIG. 4 presents schematically in plan view an example of a fabrication line in which the method and system of the invention have been applied,

FIGS. 5 to 7 present schematically in side view an example of gripper and guide units which are provided for assembling the truss of FIG. 1 and the usage of said units for assembling the truss,

FIGS. 8 to 9 present in front and side view, respectively, an example of a gate used in the system of the invention and provided with nail plate presses,

FIG. 10 presents in further detail a possible realization and operation of the gripper and guide units,

FIGS. 11 and 12 are schematical and simplified presentations in plan and side views, respectively, of an example of an assembly unit in which the method and system of the invention have been applied, FIG. 11 being a sectional view at plane XI-XI of FIG. 12, and

FIGS. 13(a) to 13(k) present an example of the assembly of the roof truss of FIGS. 1 and 2 in the unit of FIGS. 11 and 12.

### DETAILED DESCRIPTION OF THE INVENTION

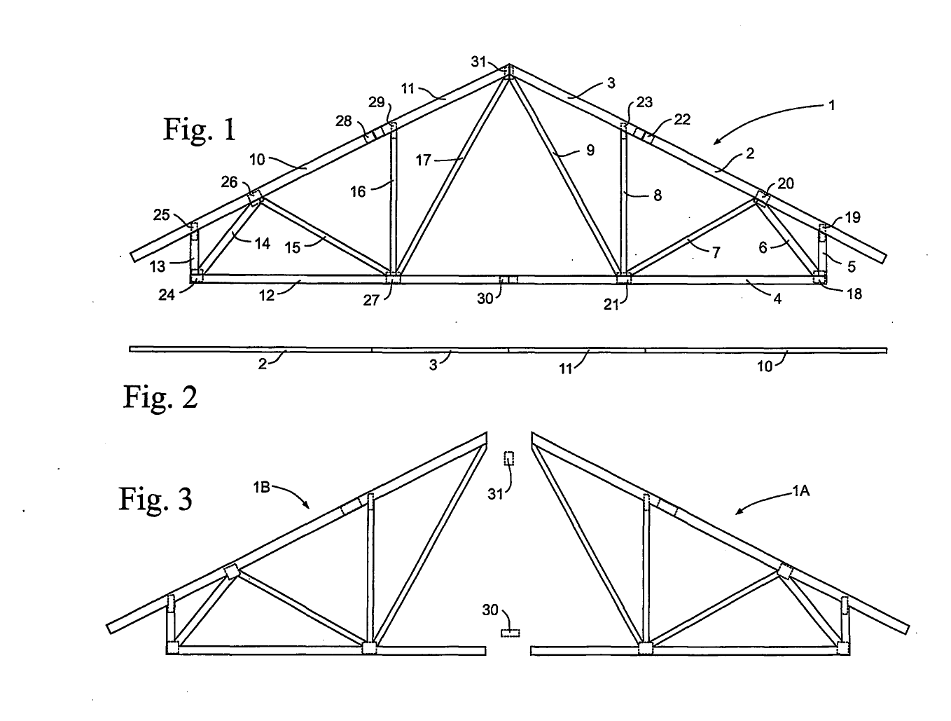

A conventional roof truss 1 of FIGS. 1 and 2 includes top chords each formed by two members 2 and 3 and 10 and 11, respectively, a bottom chord formed by two members 4 and 12, vertical support members 5, 8, 13 and 16, and diagonal support members 6, 7, 9, 14, 15 and 17. The members have been fastened to each other by means of nail plates 18 to 31. As indicated by FIG. 3, the structure may be fabricated in two parts 1A and 1B which then are fastened to each other by means of nail plates 30 and 31.

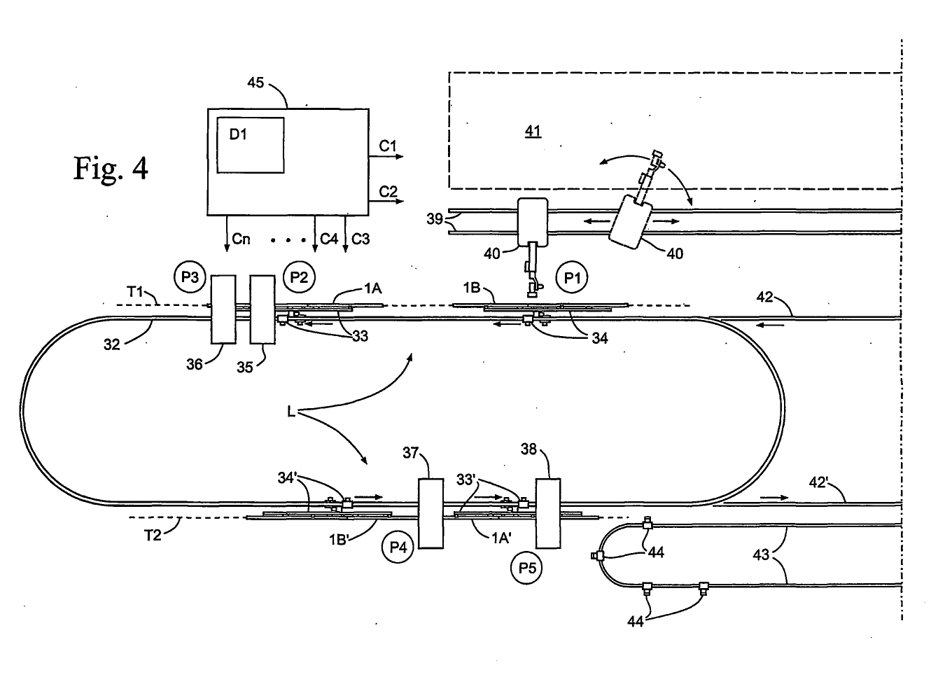

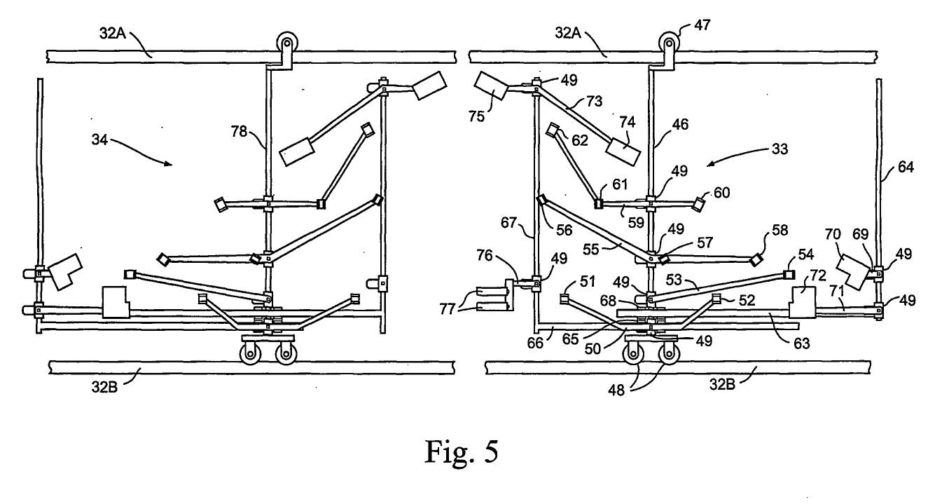

FIG. 4 presents schematically in plan view an assembly line L in which trusses of FIGS. 1 and 2 are fabricated. In the following, also FIGS. 5 to 10 are referred to in which some details of the fabrication line and process are described more thoroughly.

A line 32 and gripper and guide units 33, 34, 33′ and 34′ moving on it under control form the basic part of the assembly line. The line 32 comprises top and bottom rails 32A and 32B and is generally shaped like a circuit of a stadium. The gripper and guide units, e.g. units 33 and 34 in FIG. 5, move under control on the line. Structures are assembled in the grippers of the units (stage P1), the alignments of the members in relation to each other are checked with the guide means, and then the nail plates are set and fastened preliminarily in their places first in one or more stages P2 to P4 and are finally pressed fast in stage P5 after which the finished structure is transferred to a store. In the following, the units of the assembly line and their operation are first described in further detail and then the whole of the assembly line is considered again.

In FIG. 5, the gripper and guide units 33 and 34 have been presented. The frame of the unit 33 is formed by a vertical rail 46 moving under control along the top and bottom rails 32A and 32B on wheels 47 and 48, respectively. A professional in the art is able to realize the control and operation of the movements in many ways which are not considered here in further detail. On the vertical rail 46, several gripper devices are operating their drivers 49 moving them according to control in vertical direction and turning their arms 50, 53, 55, 59 to desired positions. One gripper device may include one or more grippers 51, 52; 54; 56, 57, 58; 60, 61, 62 which may be turned to desired positions by means of servomotors (not shown), for example.

Because the wooden members are seldom completely straight and their dimensions exact, additional guide means are needed in the assembly process with which the ends of the members forming chords or the joints between partial structures are aligned accurately enough to each other. Accordingly, in addition to gripper devices there are two guide devices in the unit of FIG. 5 there bodies being formed by a combination of a horizontal beam and a vertical rail 63, 64 and 66, 67, respectively. The bodies are movable under control on the vertical rail 46 and by means of drivers 65 and 68, respectively, also horizontally. The driver devices 49 and arms 69, 71, 73 and 76 have been realized in the same way as the corresponding parts of the gripper devices. Instead of grippers there are guide plates 70, 72, 74, 75 which are controlled and with which members to be aligned to each other are pressed, or clamps 77, e.g. flat bar clamps, with which members to be fastened to each other are pressed from both sides. The flat bars or equivalent parts are thinner than the chord or diagonal members so that they do not hinder pressing of nail plates in their places at the member joints.

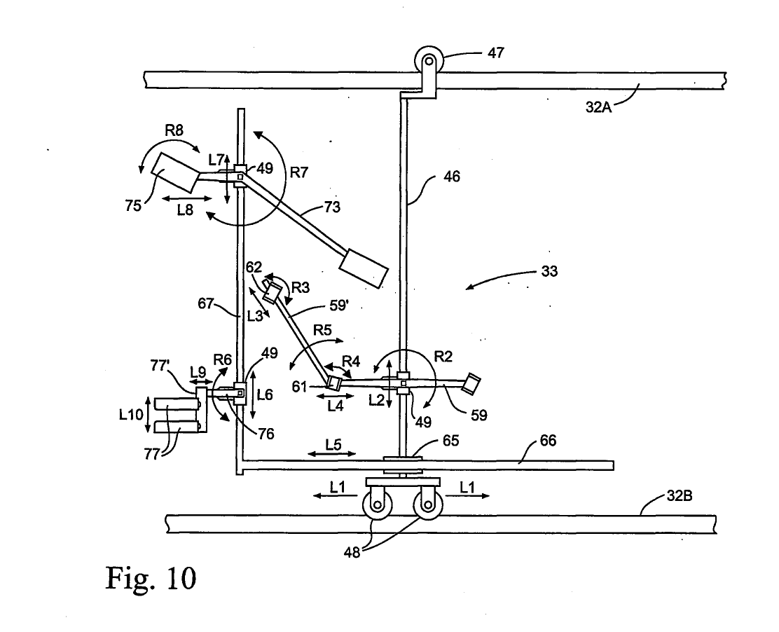

FIG. 10 presents a part of the gripper and guide unit 33 for describing a possible realization of the gripper and guide devices in further detail. The unit 33 as a whole is moving on the wheels 47 and 48 along the rails 32A and 32B as indicated by arrows L1. This happens by means of e.g. an actuator driving the wheels 48 and suitable sensors registering and checking the position of the device (not shown). The described gripper device, the frame of which is formed by beams or rails 59 and 59′, is moving and rotating on the vertical rail 46 as indicated by arrows L2 and R2, respectively, by means of its actuator 49. The gripper 61 is sliding and rotating on the beam 59 as indicated by arrows LA and R4, respectively, and the gripper 62 in the similar way on the beam 59′ as indicated by arrows L3 and R3. Additionally, the beam or arm 59′ is rotating in relation to the beam 59 as indicated by arrow R5.

In the guide device described above the whole frame is moving in relation to the frame of the unit as the beam 66 is moving by means of the driving device 65 (arrow L5). The upper guide device operating on the vertical rail 67 is moving and rotating by means of its actuator 49 as indicated by arrows L7 and R7, respectively. The guide plate 75 is sliding (arrow L8) and also rotating (arrow R8) on the beam 73. The lower clamp type guide device is moving and rotating on the rail 67 in the same way by means of its actuator 49 as indicated by arrows L6 and R6, respectively. The clamp part 77′ is sliding (arrow L9) on the beam 76, and the plates 77 forming the clamp are moving (L10) in relation to each other.

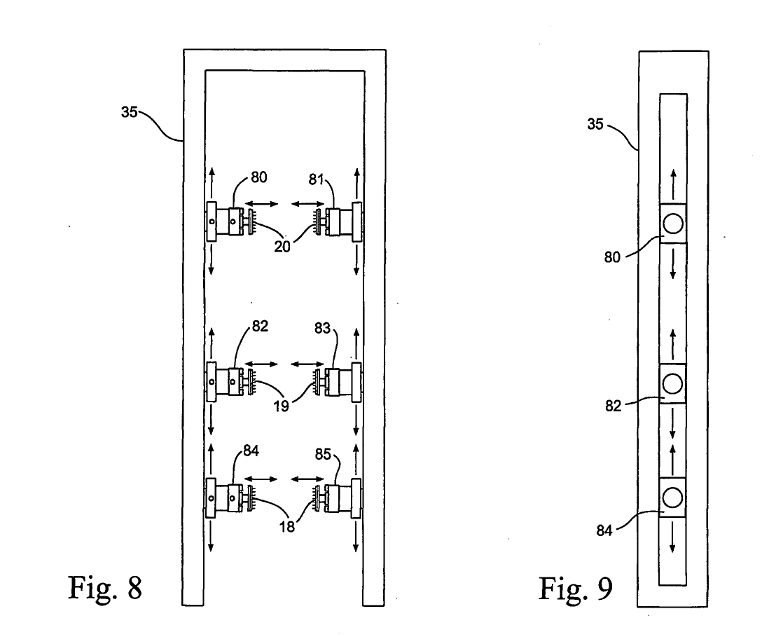

The gate 35 in which nail plates are fastened and prepressed in place is described schematically in FIGS. 8 and 9. The gate is provided with several pairs of presses 80, 81; 82, 83 and 84, 85, which may be moved under control vertically and whose gripper and press heads, in which a nail plate 18, 19 or 20 is kept for aligning and pressing it in place, may additionally be rotated. Also loading of the nail plates into the gripper and press heads by means of suitable robots or similar devices (not shown) is advantageously arranged in connection with such gates. The presses may be driven to a certain place and set under control to a certain position, in which the robot loads nail plates into them. After that the heads are steered to another certain places and positions, and a truss or partial truss moving in the line is set under control to a certain point and position in the line, whereby the nail plates and certain joints are aligned and the nail plates are pressed from both sides preliminarily onto the joints.

In the example of FIG. 4, the control is described as one control center 45, in which data D1 defining the structures or partial structures to be assembled, their members, the places and positions of the members in relation to each other and joints between the members is created for control. From the control center control signals C1 . . . Cn are brought to different parts of the system. The data may include, for example, accurate dimensions of all members and definitions of their positions, definitions of gripping points and angles for each member and the corresponding gripper of the gripper unit, definitions of places and positions for plates and clamps of the guide devices, definitions of the places and positions for the nail plates and so on. The data may include also the information about the structure and its members and other parts as a data compatible with certain 3D applications, whereby laser or other optical solutions or machine vision could be applied in alignment and check operations.

For realizing this kind of systems there are numerous alternatives for a person skilled in the art, and the realization of the control depends on the realization of the operative devices as well as control and driving devices and actuators for them. In practice, the realization may be e.g. such that a central database includes complete information about each structure or partial structure in accordance with certain specifications, and the necessary information is collected or loaded from the database to different parts of the system possibly to be first worked up and then used. These alternatives or any example of them are not described here in detail because that is not necessary for understanding the invention and because, as soon as the devices, systems and programs to be used in the realization have been selected, the realization of necessary databases is obvious and within normal professional routines for a person skilled in the art.

The assembly of a structure or partial structure happens in the system of FIG. 4 in stage P1. The loading is carried out by a robot 40, which moves on rails 39, takes according to control each member from e.g. a certain magazine from an area 41, sets the member into a certain place and position at a certain gripper, which has been steered into a certain place and position, and sets the member into said gripper, which is steered to grip it and keep it in place. The basis of the operation is that after sawing the members by means of an automatic saw, for example, they have been checked and placed in the magazines correctly and in right positions and, in view of the operation of the system, also accurately enough.

In the solution of the invention it is essential that there is no platform in the proper sense of the word, on which the structure is assembled. Instead of that, a plane T1 is defined for assembling the structure, and the grippers of the gripper and guide units have been steered to move and rotate according to control in said plane. In fact, the grippers which are moving at the other side of the circuit, where stages P4 and P5 are carried out, in a plane T2 form the basic solution of the assembly line L making possible to carry out the assembly efficiently and swiftly.

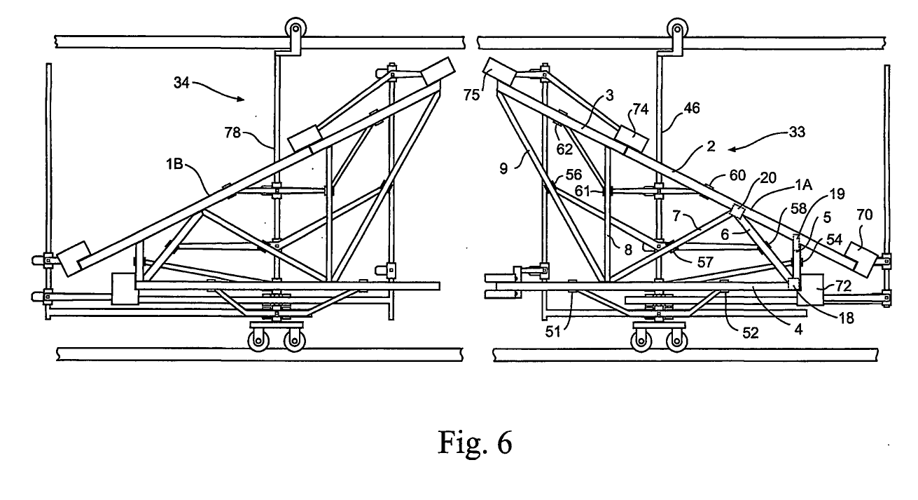

FIG. 6 presents how the partial trusses 1A and 1B of the truss 1 have been assembled in the gripper and guide units 33 and 34, respectively. The unit 33 is forwarded in the line to stages P2 and P3, i.e. to stages in which nail plates are prefastened, and the partial truss 1A is already provided with prefastened nail plates 18, 19 and 20. In the unit 34, the partial truss 1B is assembled and the guide plates have been steered to their places, so that the unit is ready to go forward in the line.

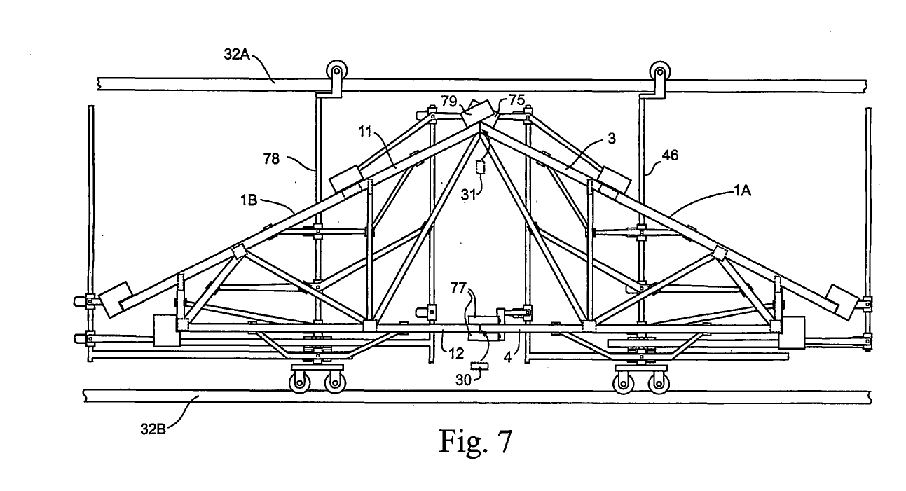

In FIG. 7 the fabrication is proceeded to stage P4 of FIG. 4 and the partial trusses 1A and 1B have been guided in their places and aligned with each other, and the nail plates 30 and 31 may be prepressed to fasten the partial trusses to each other.

The final pressing of the nail plates is carried out by means of a powerful press 38 in stage P5, after which the finished truss is taken from the gripper and guide units into a gripper 44 moving on a conveyor track 43 and is transferred to a store.

In the example described above, the guide units have been united with the gripper units. The guide units may also be realized as independent units moving along the rails 32A and 32B between the gripper units. The gripper and guide units may be designed so that one unit may be used for the assembly of various structures. Because it is possible that structures which differ largely from each other have to be assembled in the line, it is advantageous to realize the line also so that it is easy to drive units away from the line into a depot or store and bring another units to the line. This may be realized e.g. by connecting lines 42 and 42′ to the main line L by means of suitable switch mechanisms for bringing units to and respectively removing units from the line. This kind of arrangement is necessary also because it is advantageous to steer the units needing maintenance away from the line for service.

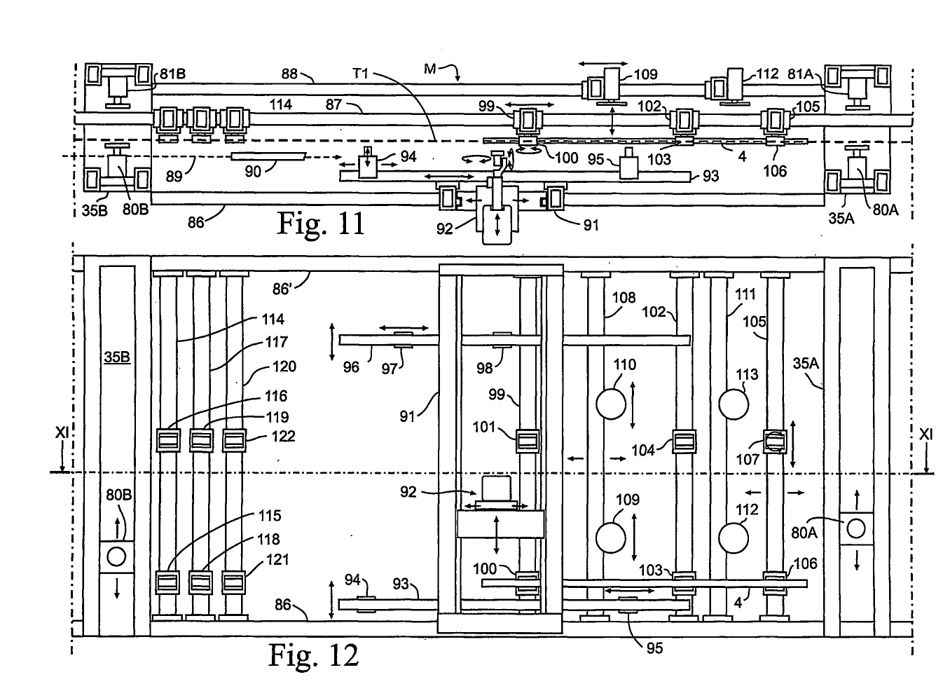

FIGS. 11 and 12 present an assembly unit M, which is at both ends provided with gates 35A and 35B, similar to the gates described with reference to FIGS. 8 and 9, for attaching the nail plates. Gripper units 99, 102, 105 and 114, 117, 120 move along a line formed by rails 87 and 87′ and extending in both directions a necessary length over the gates 35A and 35B. The gripper units are formed by columns adapted to move along the rails according to control. The corresponding grippers 100, 101; 103, 104; 106, 107 and 115, 116; 118, 119; 121, 122, six in each unit, move up and down according to control, as indicated by an arrow at the gripper 107 in FIG. 12, and rotate also according to control into a desired angle, as indicated by an arrow at the gripper 100 in FIG. 11. In FIGS. 11 and 12 the grippers 100, 103 and 106 have been steered to receive the member 4. The grip of the gripper is not described here in further detail, but it may be realized e.g. so that when gripping a member it at the same time aligns it in place for rectifying the possible faults caused by camber and twist.

The grips form also in this case a vertical plane T1 in which the assembly of a structure is carried out. The meaning is that only certain members, like chords, are set in the grippers and other members, like diagonal ones, are set in relation to them in right places and fastened by means of e.g. square brackets temporarily to wait the final fastening with nail plates. In the forward area in the plane T1 a unit 91 is moving on rails 86 and 86′, a manipulator 92 and prefastening units 93 and 96 moving and operating on the unit according to control. The manipulator 92 is operating in a similar way as the manipulator 40 described with reference to FIG. 4, i.e. it picks and sets in place the members fed to the unit. In this case the members, like a member 90 in FIG. 11, are fed along a track 89 realized with any suitable technique in a certain order and are aligned in a certain way in a certain place, from which the manipulator 92 picks them each in turn and sets in place in the grippers or in the structure to be assembled.

For setting in place and prefastening members to the basic structure, which is on the grippers, there are response units 108 and 111 moving along rails 88 and 88′ behind the plane T1, whereby the frames of the response units are formed, in a similar way as with the gripper units, by columns moving along rails according to control, on which columns corresponding response devices 109, 110 and 112, 113 are moving up and down according to control and are provided with response plates moving according to control forward and backward, so that they may be steered to support the structure to be assembled at certain defined points. The movements of the response units, devices and plates have been indicated by corresponding arrows in FIG. 11 at the device 109 and in FIG. 12 at the devices 109 and 110.

As mentioned above, the prefastening units 93 and 96 move and operate on the same frame as the manipulators 92. The unit 93 is below the manipulator and the unit 96 above it. The prefastening units are on the frame 91 according to control up and down moving beams (FIG. 12), on which prefastening devices 94, 95 and 97, 98, respectively, are moving horizontally according to control. The prefastening device is provided with e.g. a stapler head, which drives into the fastening point a suitable staple or square bracket which fastens the members preliminarily to each other.

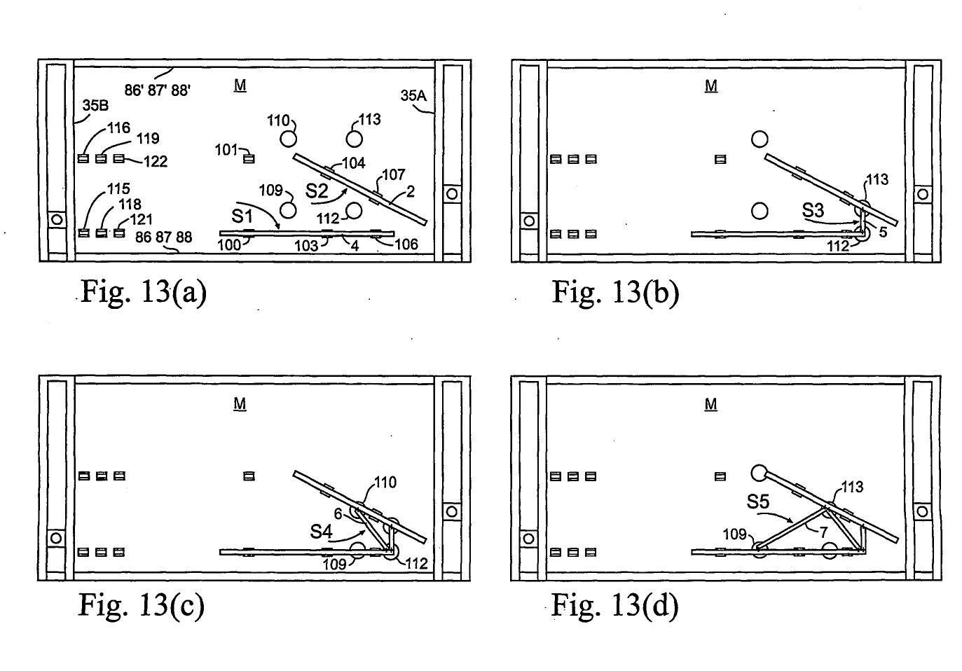

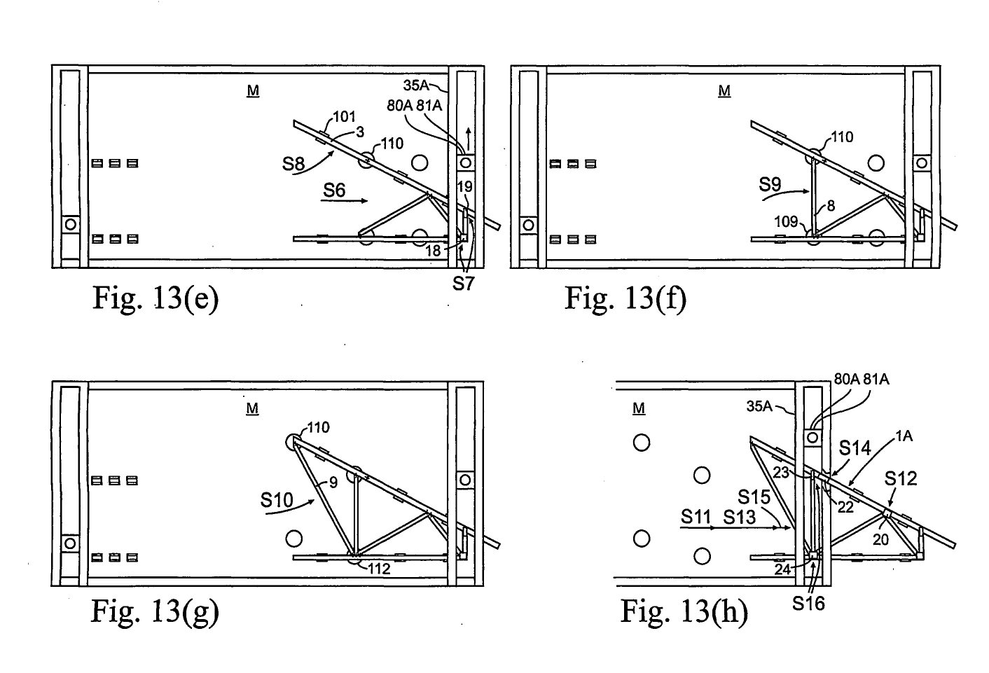

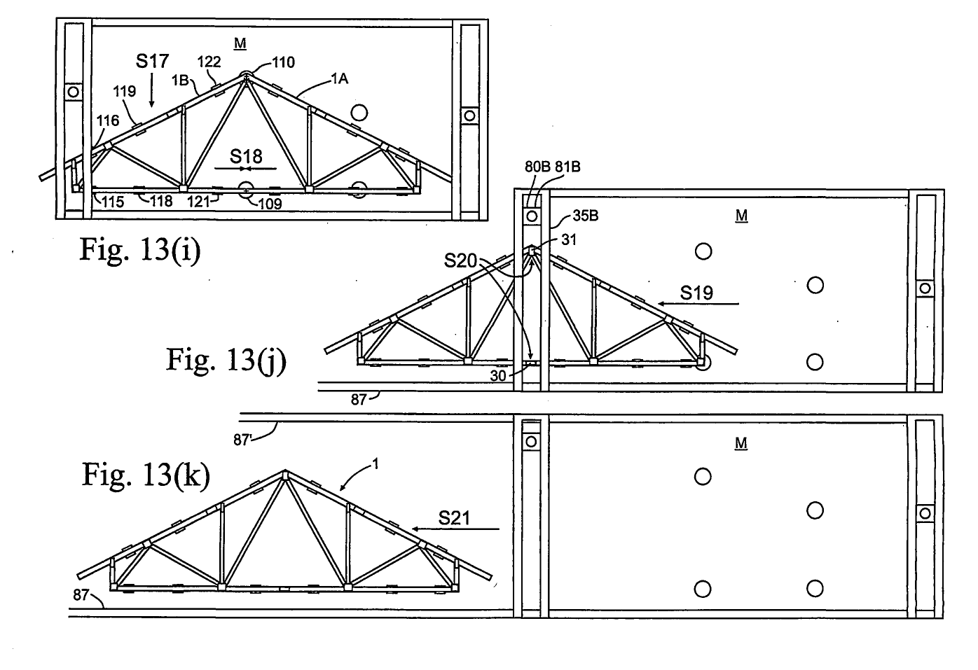

FIGS. 13(a) to 13(k) present an example of assembling the truss of FIGS. 1 to 2 in the assembly unit of FIGS. 11 to 12. The assembly unit is presented here in a simplified way, so that from the gripper units and grippers only grips are shown and from the response units only response plates, which are indicated with the reference signs of the corresponding grippers and response devices. The manipulator and the prefastening units are omitted from these drawings. Each drawing presents the situation which is achieved after certain steps.

In steps S1 and S2 in FIG. 13(a), the grippers 100, 103 and 106 have been steered to certain places to receive the bottom chord 4 of the first half 1A of the truss and, respectively, the grippers 104 and 107 to receive the top chord 2, and the manipulator has picked up these members each in turn and set it in the right place and position for the grippers which then have gripped the members and keep them in place. In step S3 in FIG. 13(b), the manipulator has picked up and set in place the vertical beam 5, and at the same time the response plates 112 and 113 have been steered into the fastening points to support the beam 5 and the prefastening devices, e.g. devices 112 and 113, steered to carry out prefastening at the both ends of the beam by means of e.g. a square bracket which binds the end of the vertical beam to the chord. In steps S4 and S5 in FIGS. 13(c) and 13(d), diagonal members 6 and 7 have been set and prefastened in a similar way in their places by means of the response plates 109, 110, 112 and 113.

In step S6 in FIG. 13(e), the structure has been moved to the right, so that it has been possible to attach the nail plates 18 and 19 in step S7 by means of the presses 80A and 81A, respectively, these nail plates fastening the vertical beam 5 finally to the chords 4 and 2. (The corresponding nail plates are attached at the same time also on the other side of the structure, but here only the nail plates attached on the front side are mentioned and indicated.) The manipulator has then in step S8 picked up the extension member 3 of the top chord and set it to the gripper 101, and at the same time the members 2 and 3 have been prefastened to each other by means of the response plate 110. In step S9 and S10 in FIG. 13(f), the vertical beam 8 has been set and prefastened in place by means of response plates 109 and 110 and, respectively, the diagonal member 9 by means of response plates 110 and 112. Thereafter, the structure has been moved in step S11 in FIG. 13(h), so that it has been possible to attach the nail plate 20 in the gate 35A in step S12, and moved further in step S13, so that it has been possible to attach nail plate 22 in step S14, and moved still further in step S15, so that it has been possible to attach nail plates 23 and 24 in step S16. The first half 1A of the truss is now ready and may be left aside to wait.

The other half 1B of the truss 1 is assembled in the same way in the other end of the assembly unit M by means of the grippers 115, 116, 118, 119, 121 and 122 and response plates 109, 110, 112 and 113. That is presented here as one carried out step S17 in FIG. 13(i). After that the halves 1A and 1B are in step S18 steered against each other in the assembly unit and prefastened together by means of response plates 109 and 110. Next, the middle point of the truss is moved in step S19 in FIG. 13(j) at the gate 35B in which the nail plates 30 and 31 are attached in step S20 fastening the halves 1A and 1B to each other. In FIG. 13(k) the finished truss is moved in the assembly line 87, 87′ to the left in which it is transferred to a store, and the gripper units are returned back to the assembly unit M.

Here above only some examples of the possible embodiments of the invention have been presented. It is clear that the devices forming the assembly plane, line or unit and the devices related to it may be realized in many different ways. This concerns as well the devices forming the line or similar unit as the devices realizing the gripper and guide units, various accessories and devices related to handling and pressing the nail plates.

The assembly line or unit may comprise also other stages and devices than what were described above. There may be check points or gates in which e.g. alignments of the members at certain joints or dimensions of the structure at defined places are checked. This kind of checks may be realized by means of laser technique or machine vision, for example.

The size and shape of the nail plates may vary widely. The grip and press heads may be realized so that they are as versatile as possible, e.g. by using suitable magnet grips. It may be thought also that the grip and press heads are easy to change and each type suitable for a certain range of nail plates.

No examples of the controllable actuators and drivers realizing the linear or rotational movements and the operation of the gripper and guide devices have been presented here above. Preferably, devices available in the market are used. Applying and combining together that kind of devices in the system described above is as such within the knowledge and normal practice of a person skilled in the art. Some examples have been described of the combinations of operations and movements to be realized. It is obvious for a person skilled in the art that many alternatives exist to realize such combinations of operations and movements. It is also clear that various operations may also be added to the system, if desired.

“A structure similar to a roof truss” referred in this application may be e.g. a frame structure for a wall element.

What is essential in the invention is that no assembly platform in the proper meaning of the definition is used but one or more planes are defined for assembly of the structure and a suitable amount of grips are arranged to move and rotate according to control in said planes, whereby the grips form the basic part of the assembly line.

The invention may vary within the scope allowed by the accompanying claims.

1. Method for fabrication of roof trusses or similar structures (1; 1A; 1B), wherein the structure is assembled from members (2-9; 10-17; 2-17) to be set against each other and the members are fastened to each other by means of nail plates or similar fastening means (18-23; 24-29; 18-31), characterized in that therein:
data (D1) defining the structure, its members, the places of the members in relation to each other and the fastening of the members to each other is produced for control,
one or more planes (T1, T2) are defined for assembly of the structure and several grippers (51, 52, 54, 56, 57, 58, 60, 61, 62; 100, 101, 103, 104, 106, 107, 115, 116) are arranged to move and rotate according to the control in said planes, whereby the grippers form the basic part of an assembly line or unit (L, M) for the structure,
the grippers are controlled to move and rotate to certain places and positions for certain members and said certain members are set in the grippers according to said data for control to form on them said structure or a defined partial structure (P1; S1, S2, S8), and
the structure is controlled to move on the grippers for carrying out the other steps (P2-P5; S3-S7, S9-S21) of the assembly process.

2. Method according to claim 1, characterized in that the plane (T1, T2) is essentially vertical and that the grippers (51, 52, 54, 56, 57, 58, 60, 61, 62; 100, 101, 103, 104, 106, 107, 115, 116) are arranged to move as a group along an essentially horizontal line (32; 87, 87′) extending in close tangential vicinity of the planes in purpose to carry the structure.

3. Method according to claim 1, characterized in that, after setting the members in the grippers, the members are further controlled (70, 72, 74, 75) to be set more accurately in place before fastening them together.

4. Method according to claim 1, characterized in that certain defined members (2, 3, 4) are set in the grippers (100, 101, 103, 104, 106, 107) to form the basic part of the structure or the partial structure (1A) and other members are fastened in place in relation to said members set in the grippers according to said data for control.

5. Method according to claim 1, characterized in that several different structures (1A, 1B) are assembled and controlled to move successively and are fastened together to form one structure.

6. System for fabrication of roof trusses or similar structures (1; 1A; 1B) from members (2-9; 10-17; 2-17) to be set against each other, which system comprises means for setting the members to form said structure and means for fastening the members to each other by means of nail plates or similar fastening means (18-23; 24-29; 18-31), characterized in that it comprises:
a database which comprises data (D1) defining the structure, its members, the places of the members in relation to each other and the fastening of the members to each other,
several grippers (51, 52, 54, 56, 57, 58, 60, 61, 62; 100, 101, 103, 104, 106, 107, 115, 116), which are controlled to move and rotate to certain places and positions in one or more planes (T1, T2), whereby the grippers form the basic part of an assembly line or unit (L, M) for the structure,
means (34, 45, 46, 49) for controlling the grippers for certain members to certain places and positions and means (40, 45) to set said certain members according to said data (D1) in the grippers to form on them said structure or a defined partial structure in defined steps (P1; S1, S2, S8) of the assembly process, and
means (32, 34, 37; 87, 87′, 99, 102, 105) for controlling the structure to move on the grippers for carrying out the other steps (P2-P5; S3-S7, S9-S21) of the assembly process.

7. System according to claim 6, characterized in that the plane (T1, T2) is essentially vertical and that the grippers (51, 52, 54, 56, 57, 58, 60, 61, 62; 100, 101, 103, 104, 106, 107, 115, 116) are arranged to move as a group along an essentially horizontal line (32; 87, 87′) extending in close tangential vicinity of the planes in purpose to carry the structure.

8. System according to claim 6, characterized in that it further comprises means (46, 49, 63, 64, 65, 66, 67, 68, 69, 70, 71, 72, 73, 74) for controlling the members, after setting them in the grippers, to be set more accurately in place in relation to each other before fastening them together.

9. System according to claim 6, characterized in that it further comprises means (91, 93-98, 108-113) for setting and fastening members in place in the basic part of the structure or the partial structure (1A) formed by certain defined members (2, 3, 4).

10. System according to claim 6, characterized in that the means for fastening the members to each other by means of nail plates or similar fastening means (18-23; 24-29; 18-31) comprise in the assembly line one or more gates or similar devices (35, 35A, 35B, 36, 37, 38) for moving the structures on the grippers through said gates or similar devices and for attaching said nail plates or similar fastening means according to control by the means (80-85; 80A, 81A, 80B, 81B) provided for that purpose in connection with said gates or similar devices.
